(19) United States
(12) Patent Application Publication
(10) Pub. No.: US 2008/0126682 A1
(43) Pub. Date: May 29, 2008

(54) Solid State Hard Disk

(76) Inventors: Gang Zhao, Sunnyvale, CA (US); Jianjun Luo, Sunnyvale, CA (US)

Correspondence Address: SILICON VALLEY PATENT AGENCY, 7394 WILDFLOWER WAY, CUPERTINO, CA, 95014, US

(21) Appl. No.: 11/764,231

(22) Filed: Jun. 18, 2007

(30) Foreign Application Priority Data
Nov. 24, 2006 (CN) 200610154854.0

(51) Int. Cl. G06F 12/00

(52) U.S. Cl. 711/103; 711/E12.008

(57) ABSTRACT

A solid state disk with multi flash controller channels is small in size, light in weight, low in power consumption and has no operating noise. In one embodiment, a flash memory based storage device comprises a hard disk protocol unit, a flash hard disk controller circuit and flash memories. The flash hard disk controller includes a protocol module, buffers, a logical circuit, a CPU, a controller interface and flash controllers. The CPU manages as many flashes as it can through multi flash controller channels. Each flash controller connects with a flash memory group and communicates with buffers and the CPU by SD/MMC/MS interface or a self-defined interface. The flash memory based storage device meets the specification specifically defined for a traditional hard disk, and communicates with a host by hard disk standard protocols and can reach or outperform the required performance.

### BACKGROUND OF THE INVENTION

1. Field of the Invention

The invention is generally related to the area of data storage devices. Particularly, the present invention is related to a solid state storage device. More particularly, the present invention is related to a hard disk using stacks of flash memory, herein also referred to as flash hard disk, wherein the flash hard disk can maintain comparable read/write speed as commonly seed in a traditional hard disk.

2. The Background of Related Art

A traditional hard disk is a non-volatile storage device that stores and provides quick access to data on rapidly rotating platters with electromagnetically charged surfaces. Such hard disks were originally introduced for computer use. As technologies develop, the hard disks have expanded to more applications, such as digital cameras, digital video recorders and video game consoles.

A hard disk, sometimes also referred to as Hard Disk Drive (HDDs) records data by magnetizing a magnetic material in a pattern that represents the data. Data ios read out by detecting the magnetization of the material. A typical HDD design includes a spindle which holds one or more flat circular disks called platters, onto which the data is recorded. The platters are made from a non-magnetic material, usually glass or aluminum, and are coated with a thin layer of magnetic material.

The platters are spun at very high speeds. Information is written to a platter as it rotates past mechanisms called read-and-write heads that fly very close over the magnetic surface. The read-and-write head is used to detect and modify the magnetization of the material immediately under it. There is one head for each magnetic platter surface on the spindle, mounted on a common arm. An actuator arm (or access arm) moves the heads on an arc (roughly radially) across the platters as they spin, allowing each head to access almost the entire surface of the platter as it spins.

Although many parts in a hard disk that are constantly being improved to increase the read/write speed and the storage capacity of the hard disk, an interface or data protocol in the hard disk gains enormous attention as it could become a bottleneck in exchanging data with other devices in a system even if everything else has been improved. There are many types of hard disk protocols, from the beginning ST-506/412, Enhanced Small Drive Interface (ESDI), Integrated Drive Electronics (IDE), Advanced Technology Attachment (ATA) to the newest Serial ATA (SATA). The access speed is improved from less 10 Mbps to 150 MB/s. For reference, FIG. 1 shows an IDE interface for the traditional hard disk. FIG. 2 shows definitions of connectors in an IDE interface. FIG. 3 shows an SATA interface for the traditional hard disk. FIG. 4 shows definitions of connectors in an SATA interface.

Although a traditional hard disk has been improved considerably in terms of speed, capacity and cost, its fundamental principle has not been changed, it still operates mechanically. Reductions in size and power consumption would soon reach its limits. Even if Hitachi has introduced micro hard disk drive, the size of which is smaller but the capacity thereof becomes limited, further the manufacturing process thereof is complicated. Therefore, solid states hard disk starts to get attentions in the storage industry, in particular, flash hard disk is getting popular due to its increasing capacity and decreasing cost.

Flash memory is non-volatile, which means that it does not need power to maintain the information stored in the chip. In addition, flash memory offers fast read access times (although not as fast as volatile DRAM memory used for main memory in PCs) and better kinetic shock resistance than hard disks. NAND flash memory is a type of flash memory constructed from electrically-erasable programmable read-only memory (EEPROM) cells, which is an array of floating gate transistors. NAND gate flash uses tunnel injection for write and tunnel release for erase. As the capacity increases and the price decreases, the NAND flash is likely massively adopted in the designs of the flash hard disk.

In the current flash hard disk design, a CPU is always included to manage the data exchange between a host and a flash hard disk. In particular, the CPU needs to manage flash channels, flash wear-leveling and ECC algorithm and so on. With the inherently relative slower read/write speed in flash memory compared to that in a traditional hard disk, the performance of a flash hard disk is currently not satisfactory. Thus there is a need for improving the performance of a flash hard disk.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to a solid stat storage device. According to one aspect of the present invention, to increase the capacity as well as read/write speed, a flash hard disk includes respective memory mechanisms or modules, each operating independently but all of the memory modules operating under the management of a CPU. Because each of memory modules includes its own internal CPU that manages its own read/write functions, the memory modules work independently from each other. Through a predefined interface, a data buffer is provided to buffer data being written into or read from the memory modules.

According to another aspect of the present invention, a flash hard disk with multi flash controller channels contemplated in the present invention is small in size, light in weight, low in power consumption and has no operating noise. Such a flash hard disk comprises a hard disk protocol unit, a flash hard disk controller circuit and flash memories. The flash hard disk controller includes a protocol module, buffers, a logical circuit, a CPU, a controller interface and flash controllers. The CPU manages as many flashes as it can through multi flash controller channels. Each flash controller connects with a flash memory group and communicates with buffers and the CPU by SD/MMC/MS interface or a self-defined interface. The flash memory based storage device meets the specification specifically defined for a traditional hard disk, and communicates with a host by hard disk standard protocols and can reach or outperform the required performance.

The present invention may be implemented in many forms, including a device, a system or a part of a system. According to one embodiment, the present invention is a solid state storage device that comprises: a plurality of memory modules, each including a controller and a stack of memories, and operating independently from each other, wherein the controller is configured to facilitate data exchange between the memories and a first interface; a buffer; and a CPU configured to manage data exchange between the memory modules and a host via the first interface and a second interface, wherein data being written into or read out from the memory modules is buffered in the buffer first. Each of the memory modules is configured to contribute to part of a read/write process with the host in parallel, thus a read/write speed of the solid state storage device meets a standard already defined for a traditional hard disk. The second interface is designed in accordance with the standard specifically defined for a traditional hard disk.

One of the objects, features, and advantages of the present invention is to provide a solid state storage device with comparable read/write speed and performance.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows an IDE interface for the traditional hard disk;

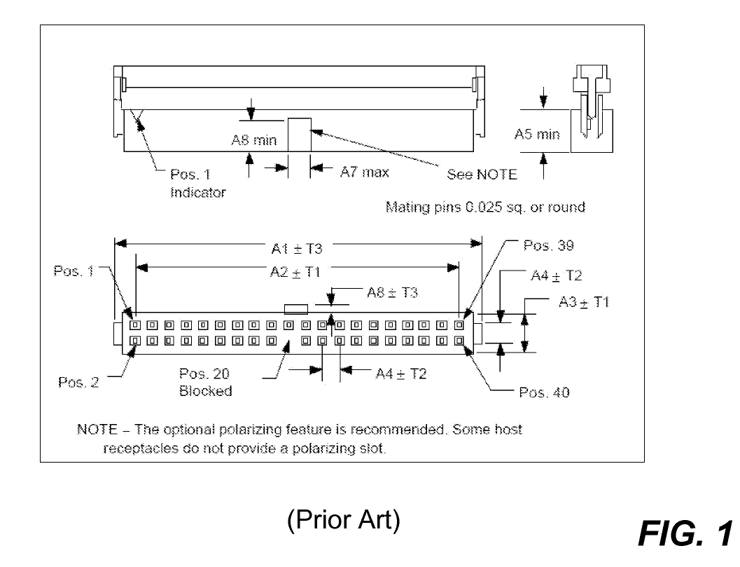

FIG. 2 shows definitions of connectors in an IDE interface;

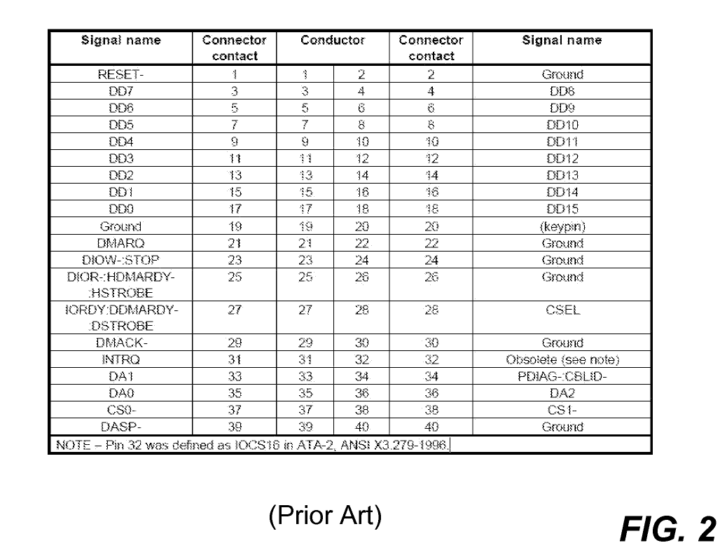

FIG. 3 shows an SATA interface for the traditional hard disk;

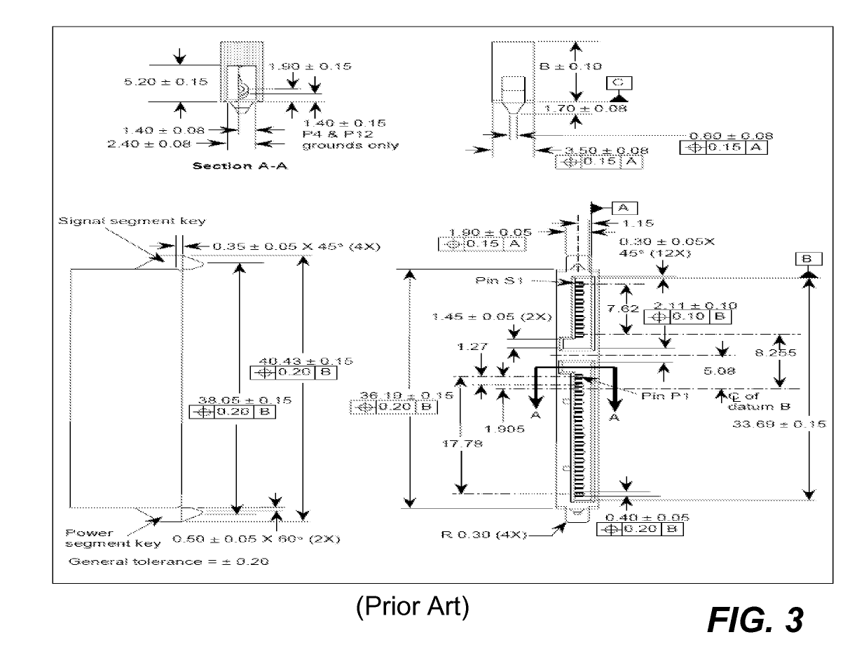

FIG. 4 shows definitions of connectors in an SATA interface;

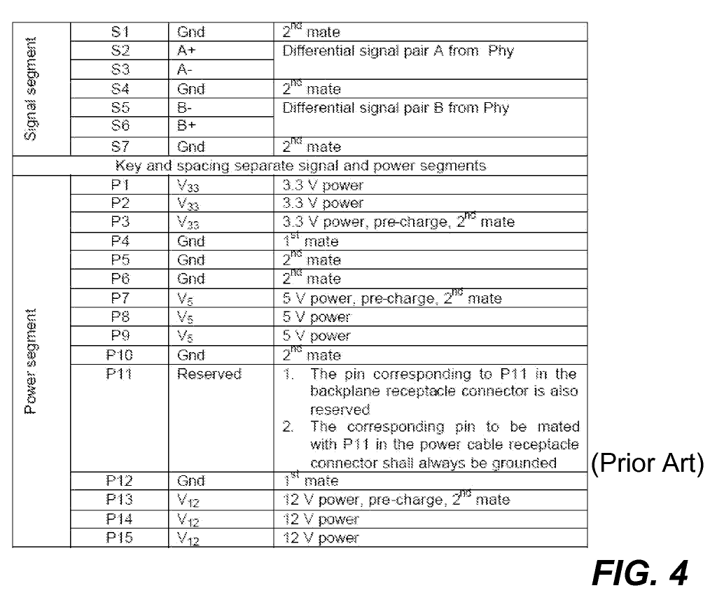

FIG. 5 shows an exemplary configuration of a flash hard disk;

FIG. 6 shows an exemplary detailed blocks diagram of a flash hard disk excluding a hard disk protocol unit;

FIG. 7 shows a typical example of a flash controller;

FIG. 8 shows a flash hard disk controller including a SATA protocol unit, buffers, a logical circuit, a CPU, an SD interface, and coupled to eight memory modules or eight memory circuits with eight respective flash controller channels;

FIG. 9 shows another example of a flash hard disk with multi flash controller channels; and

FIG. 10 shows a flash hard disk controller communicating with flash memories by a self-defined internal interface and a plurality of flash controller channels.

### DETAILED DESCRIPTION OF THE PREFERRED EMBODIMENTS

The detailed description of the invention is presented largely in terms of procedures in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams, if any, representing one or more embodiments of the invention do not inherently indicate any particular order nor imply any limitations in the invention.

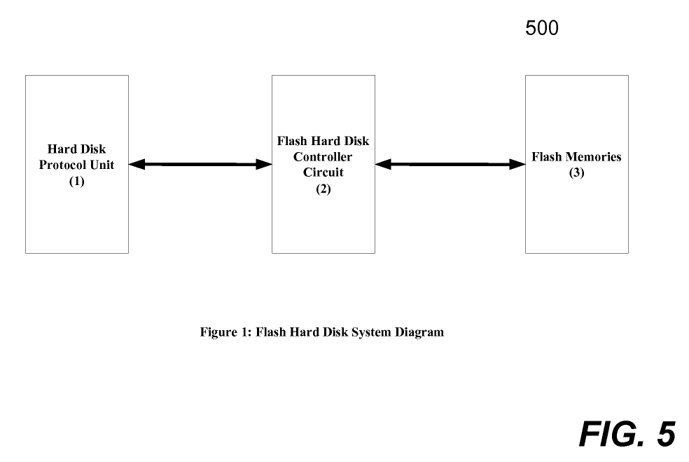

Referring now to the drawings, in which like numerals refer to like parts throughout the several views. FIG. 5 shows an exemplary configuration of a solid state storage device 500. Because the solid state storage device 500 uses flash memories as the memory cores, it is also herein referred to as a flash hard disk, meaning it can replace a traditional hard disk. However, nothing is implied that such a flash hard disk can not be used anywhere else. In fact, those skilled in the art in view of the description herein can appreciate that such a flash hard disk may be used in any devices that require a storage space with large capacity and high read/write performance.

As shown in FIG. 5, the flash hard disk 500 includes a hard disk protocol unit 502, a flash hard disk controller circuit 504 and flash memories or cores 506. The hard disk protocol unit 502 is provided to be responsible for communication between a host and the hard disk 500. In one embodiment, one side of the hard disk protocol unit 502 communicates with a protocol module in the flash hard disk controller by the IDE (ATA) protocol or SATA protocol, and the other side of it communicates with the host.

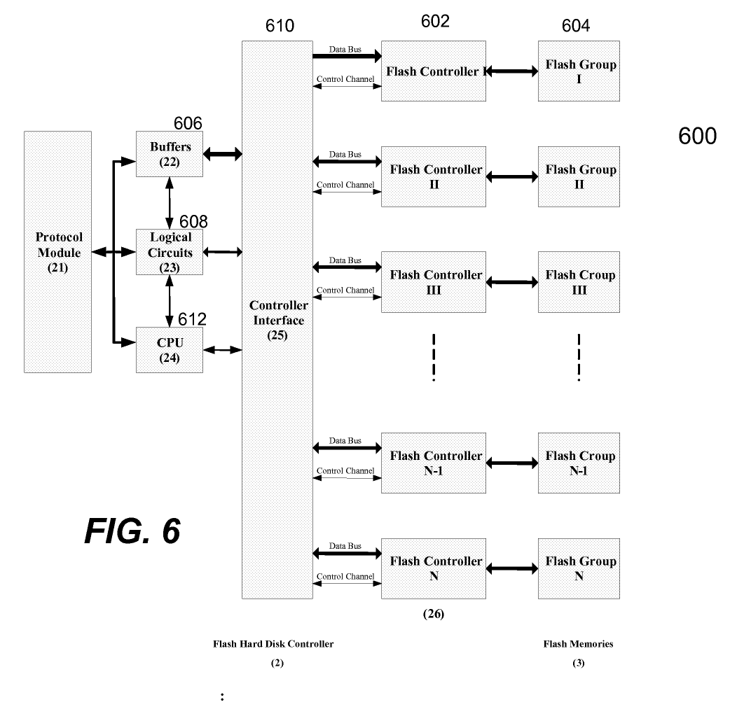

The flash hard disk controller circuit 504 includes a protocol module, buffers, a logical circuit, a CPU, a controller interface and a number of flash controllers. FIG. 6 shows an exemplary detailed blocks diagram of a flash hard disk 600 excluding a hard disk protocol unit. The flash hard disk 600 shows that every flash controller 602 is coupled to a flash group 604. The flash group 604 may be one or more flash cores that can be serially or parallel connected to retain data. All flash controllers communicate with the buffers 606 and the CPU 612 through a controller interface circuit 610. The CPU 612 is configured to manage the flash controllers 602 via the flash controller channels to store and access data in the respective flash memories 604.

As each of the flash controllers 602 operates on its own and even contributes to some of the process that would otherwise be performed by the CPU 612, thus the CPU 612 can manage as many flash groups as there can be. Depending on implementation, the controller interface 610 may be, but not be limited to, SD, MMC or MS interface. The flash hard disk controller 504 can be a single chip controller or integrated by several controller circuits.

In operation, each of the flash controllers 602 and one of the flash cores 604 form a memory module that is allocated a channel. The flash controllers 602 or the memory modules work independently but under the management of CPU 612 to exchange data with a host. In one embodiment, there are at least eight data channels (eight flash memory modules), the data is exchanged in parallel and each controller or memory module operates individually, thus the read/write speed with the flash cores can be kept to or outperform the speed of IDE or SATA (150 MB/s). In addition, the flash hard disk can also work with other various standards that may be applied to a traditional hard disk, such as PCI, PCI express and Compacflash, or a public or private standard.

The data is processed respectively in N parallel flash controller channels. Each flash controller channel deals with 1/N data and the data bus can be 4/8/16/32 bit. Thus, the speed requirement for the flash memory is greatly decreased. By this way, the flash hard disk is able to manage many flashes to contribute to the demanded high speed read/write. Moreover, multi flash controller channels take over parts of responsibility of the CPU, such as flash ECC management and flash wear-leveling algorithm. Therefore, the CPU can readily manage flash data by monitoring the signals from the flash controllers and managing the flash controller channels.

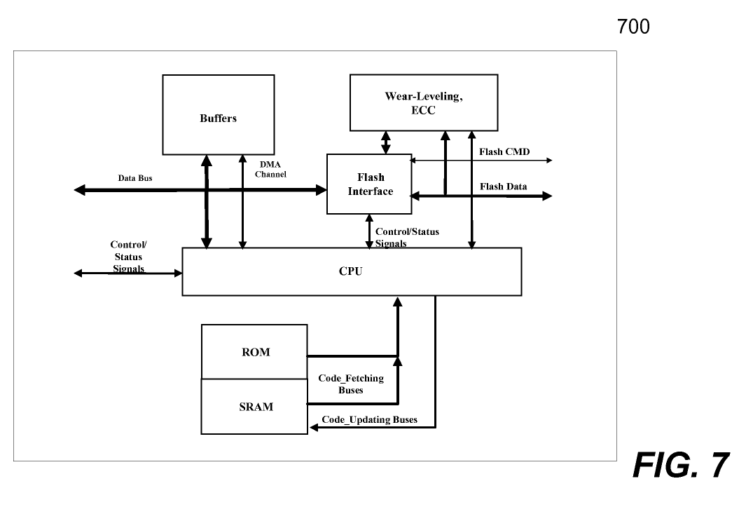

In one embodiment, each of the flash controllers 602 includes an internal CPU with embedded firmware by which the embedded CPU can control the corresponding logical circuit to manage the flash data channels and support flash data wear-leveling algorithm. FIG. 7 shows a typical example of a flash controller 700. One of the advantages of the embedded CPU firmware is that it is flexible to upgrade functions. Moreover, the flash controller can be a hardware circuit, which is less flexible. The flash controller takes over part of work of the CPU managing the flash hard disk (a.k.a. flash hard disk CPU) so the flash hard disk CPU can manage as many flash cores as possible. Therefore, the capacity of the flash hard disk with multi flash controller channels is not limited, at least in theory.

When a host writes data to the flash hard disk, the data is stored in the buffer by IDE (ATA) or SATA protocol through the hard disk protocol unit. The CPU monitors the signals from the flash controllers and manages the buffer to send data to a selected flash controller. Then, the flash controller manages the corresponding flash core to write the data therein.

When the host reads data from the flash hard disk, a selected flash controller reads the data from the corresponding flash core. The CPU collects the data from the flash controller and buffered the data in the buffer. Then, the CPU delivers the data from the buffer to the host by IDE (ATA) or SATA protocol.

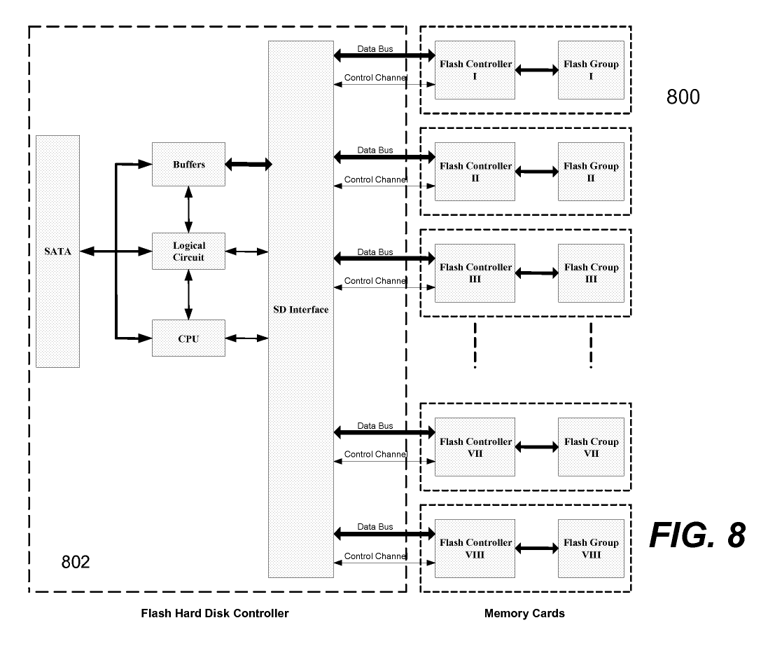

For example, there is a flash hard disk with multi flash controller channels using the SATA protocol for the protocol unit and the SD protocol for the controller interface. As shown in FIG. 8, the flash hard disk controller 802 includes a SATA protocol unit, buffers, a logical circuit, a CPU, an SD interface, and is coupled to eight memory modules or eight memory circuits with eight respective flash controller channels. When the host writes data to the flash hard disk, the SATA protocol unit is a bridge between the host and the flash hard disk controller 802, and facilitates data exchange therebetween. The CPU operates the logical circuit to store the data in the buffers. When the buffers are full or the host stops sending the data, the CPU delivers the data from the butters to the flash core through the SD interface and one or more corresponding flash controller channels. By the SD interface and the flash controller channel, the data is sent to the selected memory modules(s).

When the host reads data from the flash hard disk, one or more flash controllers read the data from the corresponding flash in the memory modules(s) and deliver the data to the CPU through one or more flash controller channels. The CPU collects the data in the buffers. Then, the CPU operates the logical circuit to send the data from the buffers to the host by the SATA protocol. It should be noted that the protocol unit shown in FIG. 8 is not limited to the SATA protocol, the controller interface is not limited to SD interface, and the number of the flash controller channels is not limited to be eight.

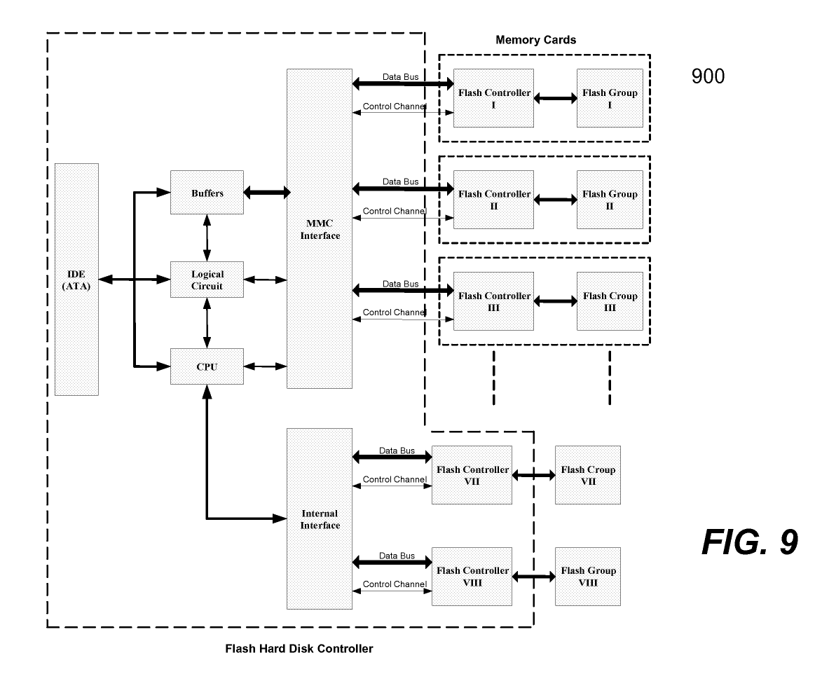

Referring to FIG. 9, there is another example of a flash hard disk with multi flash controller channels. The flash hard disk uses the IDE (ATA) protocol for the protocol unit and the MMC protocol for the controller interface. In addition, instead of communicating with the flash cores by SD interface and the flash controllers, the CPU can send or receive the data through the MMC interface to memory modules, or through a self-defined internal interface and flash controller channels to the flash cores. The protocol unit is not limited to SATA or IDE and the controller interface is not limited to SD or MMC. Therefore, the flash hard disk controller can include an IDE hard disk protocol unit, buffers, a logical circuit, a CPU, a MMC interface, an internal interface and multi flash controllers.

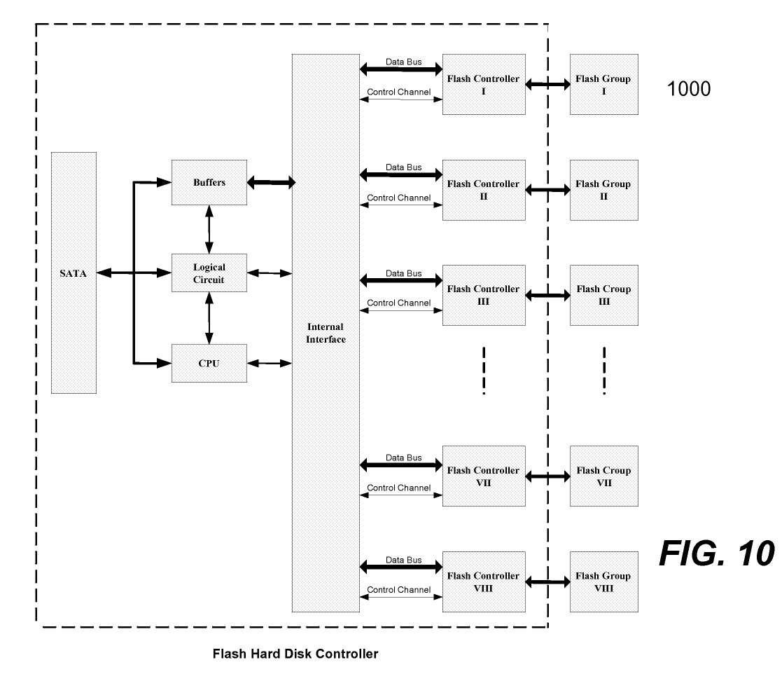

Moreover, the flash hard disk controller can communicate with flash memories only by a self-defined internal interface and flash controller channels, as shown in FIG. 10. The flash hard disk includes a SATA protocol unit, buffers, a logical circuit, a CPU, an internal interface and flash controllers. The flash hard disk protocol unit is not limited to the SATA protocol and the internal interface can be SD, MMC or MS interface but not limited to. In addition, the number of the flash controller channels is not limited to be eight.

The processes, sequences or steps and features discussed above and in the appendixes are related to each other and each is believed independently novel in the art. The disclosed processes and sequences may be performed alone or in any combination to provide a novel and unobvious system or a portion of a system. It should be understood that the processes and sequences in combination yield an equally independently novel combination as well, even if combined in their broadest sense; i.e. with less than the specific manner in which each of the processes or sequences has been reduced to practice in the attached appendix.

The forgoing and attached are illustrative of various aspects/embodiments of the present invention, the disclosure of specific sequence/steps and the inclusion of specifics with regard to broader methods and systems are not intended to limit the scope of the invention which finds itself in the various permutations of the features disclosed and described herein as conveyed to one of skill in the art.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. While the embodiments discussed herein may appear to include some limitations as to the presentation of the information units, in terms of the format and arrangement, the invention has applicability well beyond such embodiment, which can be appreciated by those skilled in the art. Accordingly, the scope of the present invention is defined by the appended claims rather than the foregoing description of embodiments.

1. A solid state storage device comprising:
a plurality of memory modules, each including a controller and a stack of memories, and operating independently from each other, wherein the controller is configured to facilitate data exchange between the memories and a first interface;
a buffer; and
a CPU configured to manage data exchange between the memory modules and a host via the first interface and a second interface, wherein data being written into or read out from the memory modules is buffered in the buffer first.

2. The solid state storage device as recited in claim 1, wherein each of the memory modules is configured to contribute to a read/write process with the host in parallel, a read/write speed of the solid state storage device meets a standard already defined for a traditional hard disk.

3. The solid state storage device as recited in claim 2, wherein the second interface is designed in accordance with the standard specifically defined for a traditional hard disk.

4. The solid state storage device as recited in claim 2, wherein the second interface is one of Enhanced Small Drive Interface (ESDI), Integrated Drive Electronics (IDE), Advanced Technology Attachment (ATA), and Serial ATA (SATA).

5. The solid state storage device as recited in claim 1, wherein the stack of memories is flash memories.

6. The solid state storage device as recited in claim 5, wherein the controller includes an internal CPU with updatable firmware.

7. The solid state storage device as recited in claim 6, further comprising a logic circuit.

8. The solid state storage device as recited in claim 7, wherein the internal CPU manipulates the firmware to control the logical circuit to manage respective data channels with the memory modules in accordance with a data algorithm.

9. The solid state storage device as recited in claim 8, wherein the internal CPU takes on partial work that would otherwise be done by the CPU so that the CPU is configured to have a capacity to manage a large number of such memory modules.

10. The solid state storage device as recited in claim 9, wherein the memory modules are integrated in one integrated circuit.

11. The solid state storage device as recited in claim 7, wherein the controller includes a flash interface to facilitate data exchange between the flash memories and the first interface.

12. The solid state storage device as recited in claim 11, wherein the first interface is one of SD/MMC, USB, SD, MMC, SM, MS and CF.

13. An integrated circuit comprising:
a plurality of connections allocated respectively to be coupled to a plurality of memory modules, each of the memory modules including a controller and a stack of memories, and the memory modules operating independently from each other;
a buffer, a logic circuit, and a CPU, all coupled to the memory modules via the connections, wherein the CPU is configured to manage data exchange between the memory modules and a host via a first interface and a second interface, wherein data being written into or read out from the memory modules is buffered in the buffer first.

14. The integrated circuit as recited in claim 13, wherein each of the memory modules is configured to contribute to a read/write process with the host in parallel, the read/write process would be otherwise undertaken by the CPU.

15. The solid state storage device as recited in claim 2, wherein the first interface is in compliance with a flash memory standard interface, and the second interface is designed in accordance with a standard specifically defined for a traditional hard disk.

16. An integrated circuit comprising:
a plurality of connections;
a plurality of controllers operating independently from each other, and coupled respectively with a plurality of flash memories via the connections;
a buffer, a logic circuit, and a CPU, all coupled to the controllers, wherein the CPU is configured to manage data exchange between the memories and a host via a first interface and a second interface, wherein data being written into or read out from the memory memories is buffered in the buffer first.

17. The integrated circuit as recited in claim 16, wherein each of the memory modules is configured to contribute to a read/write process with the host in parallel, the read/write process would be otherwise undertaken by the CPU.

18. The solid state storage device as recited in claim 17, wherein the first interface is in compliance with a flash memory standard interface, and the second interface is designed in accordance with a standard specifically defined for a traditional hard disk.
